(19) United States
(12) Patent Application Publication
(10) Pub. No.: US 2011/0063709 A1
(43) Pub. Date: Mar. 17, 2011

(54) ELECTROCHROMIC FORMULATION WITH AT LEAST TWO DYE SYSTEMS, METHOD FOR PRODUCTION THEREOF AND ELECTROCHROMIC COMPONENT

(75) Inventors: Andreas Kanitz, Höchstadt (DE); Marek Maleika, Fürth (DE); Gotthard Rieger, Erlangen (DE); Wolfgang Roth, Uttenreuth (DE)

(73) Assignee: SIEMENS AKTIENGESELLSCHAFT, Munich (DE)

(21) Appl. No.: 12/736,900

(22) PCT Filed: May 18, 2009
(86) PCT No.: PCT/EP2009/055995

§ 371 Date: Nov. 19, 2010

(30) Foreign Application Priority Data
May 19, 2008 (DE) 10 2008 024 187.3

(51) Int. Cl. G02F 1/153; G02F 1/00

(52) U.S. Cl. 359/273; 252/583

(57) ABSTRACT

Electrochemically active formulations may be used for flashing electrochromic displays, in particular for those that in addition to blinking can switch on a permanent symbol with the blinking display. The formulations contain at least two chemically different dye systems. The formulations provide a first dye system that is reversibly switchable at a low voltage, hence suitable for blinking representation of symbols. A second dye system is activated at a higher voltage and is suitable for permanent display of symbols due to the bistability or irreversibility thereof.

### CROSS REFERENCE TO RELATED APPLICATIONS

This application is the U.S. national stage of International Application No. PCT/EP2009/055995, filed May 18, 2009 and claims the benefit thereof. The International Application claims the benefits of German Application No. 102008024187.3 filed on May 19, 2008, both applications are incorporated by reference herein in their entirety.

### BACKGROUND

Described below are electrochromically active formulations for flashing electrochromic displays, especially for those which, in addition to the flashing, can also display a permanent symbol on the flashing display. The formulations provide a first color system that is reversibly switchable at a low voltage, and so is suitable for flashing display of symbols. A second color system is activatable at a higher voltage and, due to its bistability or irreversibility, is suitable for the permanent display of symbols.

Electrochromic displays based on organic materials normally have an active electrochromic layer which, in the case of a display, is between electrodes at right angles to one another. Essential constituents of the active layer are a redox system and a dye. The application of a voltage shifts the concentration ratio of redox partners to one another within the material. In this reaction, protons and/or ions are released or bound within the material. If a voltage is applied to the material, the shift in the equilibrium of redox partners present at the two electrodes runs in the opposite direction. This can be made visible, for example, by a pH-active dye.

One principle in the implementation of electrochromic displays lies in bringing about the color change not by the alteration of the pH in the display, but by utilization of the redox processes which take place in any case, in order to obtain high-contrast color change by the formation of reductive and/or oxidative states in suitable materials. In particular, the materials known as viologens and polythiophenes have become known as material classes.

Specific display elements require the display both of flashing symbols and of permanently displayed symbols. For this purpose, formulations with the appropriate stabilities in each case for the color change have to be used in the switched state and with zero current flow. These are applied, for example by a suitable application process such as screen printing, to appropriate, locally separated points on a display element. However, this procedure is technically complex.

### SUMMARY

It is therefore an aspect to provide a formulation for an electrochromic electronic and organic component, by which color changes of different stability can be obtained with zero current flow.

This can be provided by an electrochromic formulation for an organic electronic component, in which at least two chemically different color systems are present, the first of which is reversibly switchable at a low voltage and the second is activatable at a higher voltage. A process for producing an electrochromic formulation includes the following process: mixing an electrochromic color system which is reversibly switchable at low voltage with a bistably or irreversibly switchable color system, then adding solvents to the mixture such that the electrochromic formulation is in the form of a paste applicable to electrode layers. An electrochromic organic electronic component is also described, having at least one active electrochromic organic layer between two electrodes, wherein at least two electrochromic color systems switchable at different voltages and/or power pulse lengths are present in the at least one electrochromically active organic layer.

### DETAILED DESCRIPTION OF THE PREFERRED EMBODIMENT

In the present context, “reversibly switchable” is understood to mean that the color system has a color change which is stable for a short period with zero current flow and is therefore suitable for flashing display of symbols in the display device.

In the present context, “bistably” and/or “irreversibly” switchable is understood to mean that the color system has a color change which is stable for a long period with zero current flow and is therefore suitable for the permanent display of symbols. The distinction between bistable and irreversible arises from the fact that a bistable color system recovers its original color again as a result of reversal of polarity, whereas the irreversibly switched color system cannot be returned back to the starting state.

The formulations provide a first color system that is reversibly switchable at a low voltage, and so is suitable for flashing display of symbols. A second color system is activatable at a higher voltage and, due to its bistability or irreversibility, is suitable for the permanent display of symbols.

A color system is always understood to mean, even in isolation, a switchable coloring component for an organic electronic electrochromic component. This component may under some circumstances contain two or more individual chemical compounds, for example a 4,4′-bipyridinium salt and a ferrocene, or a sulfur compound which dimerizes in a redox equilibrium and a metal salt.

Accordingly, a mixture of at least two electrochromically active color systems is obtained in a formulation, and the switching behavior of the individual color systems is substantially independent of the others.

For example, a first electrochromically active color system with the following properties is used: a redox system which changes color as a result of electron acceptance or release. This color system is reversibly switchable at low voltage (down to 1.5V). In the ground state, the system, for example, is colorless, and in the switched state, for example, blue. With zero current flow, the system reverts to the colorless state, but it can also be actively switched back. By alternating reversal of polarity, it is thus possible to display flashing symbols. The first electrochromically active color system thus ensures that it flashes, for example, by virtue of an electrochromically switching redox pair.

For this purpose, for example, a second electrochromically active system with the following properties is added to the mixture:

In contrast to the first color system, the second color system is activatable only at a higher voltage of 2.5-3 V. At low voltage, it remains completely unchanged and substantially inactive in the formulation.

In an advantageous configuration, the second color system reacts bistably in the event of a relatively short voltage pulse (5-10s), in the sense that it reverts to the, for example, colorless starting state with zero current flow only after a prolonged period (for example 1 hour to several hours, approx. 10 hours), and is switched irreversibly under the action of a longer voltage pulse, and so does not revert back to the starting state at all, and cannot be returned back to the starting state by reversal of polarity either.

In the case of bistable switching, after the second system has been switched back to its colorless ground state (the polarity has been reversed), the formulation is back in its starting state, and, for example, the first color system can then be used again for the display of flashing symbols.

Under the action of a longer voltage pulse (20-30 s), the second system reacts irreversibly in the sense of a chemically irreversible reaction; the permanent display of a symbol is possible. Thereafter, reverse switching of the second system is no longer possible.

For example, the second electrochromically active color system used, which is switchable at higher voltage, may be a color system which exhibits bistable behavior by virtue of a sulfur compound which dimerizes in a redox equilibrium in the presence of at least one metal salt.

As long as the activatable color system is operated at low voltage, the color system activatable at higher voltage remains inactive. At higher voltage, for example, both color systems are activated, in which case the color impressions of the individual color systems are generally superimposed. If the color impression generated by the first color system is, for example, blue and the color impression generated by the second color system is, for example, black, the overall color impression at higher voltage is a black color impression. In the switched-back state with zero current flow, both color systems are, for example, colorless.

Also conceivable are first color systems which are reversibly switchable only with a prolonged power pulse and therefore cannot be switched in the case of a short power pulse, even one of relatively high voltage, such that coloring of the display element which is brought about solely by the color change of the color system switchable at relatively high voltage can be obtained.

Surprisingly, both systems may be present alongside one another in one and the same formulation (as a mixture) without influencing one another. This applies to the behavior in an electrical field and to the storage stability of the formulation.

Examples of the first color system are redox chromophores, for example those based on bipyridinium salts, such as the polymeric 4,4′-bipyridinium structures which are separated from one another by an alkylene spacer, the alkylene spacer having 3 to 25 carbon atoms, at least some of which are known from PCT/EP2006/064048. The color system includes, for example, a component with the following base structure:

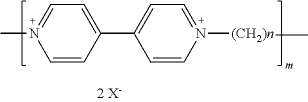

n=10-20;
m=10-200;
   X=any anion, such as halide and/or trifluoromethylsulfonate.

Examples of the second color system are, for example, those which are switched with an irreversible chemical reaction, as known, for example, PCT/EP2007/052984, bistable systems in which at least one zwitterionic structure is present, as known from PCT/EP2007/059931, is present, or color systems which, in addition to a metal salt or metal salt mixture, also contain a redox-active multisulfur compound as known from the parallel application from the same inventors.

This component, which contains at least one sulfur compound which dimerizes in a redox equilibrium and a metal salt or metal salt mixture stabilizes the “irreversible” state for at least several hours.

Suitable metal salts are those from transition groups 1, 2, 6, 7, 8, and main groups 5 and 6. Particularly suitable are nickel and cobalt salts, especially nickel(II) bromide and cobalt(II) acetate.

The ratio of the two color systems may be varied. An advantageous ratio is an equimolar ratio of a color system which switches at low voltage, for example the 4,4′-bipyridinium salt with a ferrocene or ferrocene derivative, a corresponding metal salt and/or metal salt mixture and a corresponding sulfur compound dimerizable in a redox equilibrium.

An advantageous configuration of the organic electronic electrochromic component is the design of the electrodes. At least one of the two electrodes, for example a transparent ITO electrode of the electrochromic organic electronic component, is structured. In addition, individual regions which correspond, for example, to different symbols can be addressed with different voltages. For instance, it is possible to define regions with low voltage supply in long or short pulses, in which only the first color system is activated. In the regions with higher voltage supply, both color systems can be activated.

### WORKING EXAMPLES

### 1. Preparation of the Formulation

3 g of titanium dioxide are mixed vigorously with 0.3 g of poly-N,N′-(dodecylene)bipyridinium dibromide and 0.12 g of ferrocene (color system 1), and also 0.3 g of nickel(II) bromide and 0.28 g of 4,5-di-S-methyl-1,3-dithiol-2-one (color system 2), using, e.g., a Speedmixer at 2000 rpm for 5 minutes. Subsequently, the resulting powder is dispersed in 2 g of diethylene glycol by, e.g., a Speedmixer at 2000 rpm for 5 minutes. A light-colored spreadable paste is obtained.
2. Production and switching of an electrochromically active cell. The formulation is applied between two ITO-coated films by screen printing, with an adhesive frame delimiting the printed area. The adhesive frame also bonds the two films to one another. The thickness of the printed layer is 30 μm. The electrochromic display element produced in this way has a white color impression.
3. Electrical switching of the electrochromically active cell
4. The switching of the cell is accomplished by applying a voltage with alternating signs. The following switching modes are possible:
   a. At a voltage of −1.5V, a blue color impression is obtained at the cathode. After reversal of polarity, the white color impression of the starting state is formed again. The color change can be brought about as often as desired.
   b. At a voltage of −3V, a black color impression arises at the cathode, which is preserved over several hours even with zero current flow after switching for 15 seconds. By reversing the polarity, the white starting state can be re-established. After further switching operation with +/−1.5V, the reversible color system 1 can be activated again and switched back and forth between its color states as often as desired.
   c. Switching operation with −3V. A black color impression is obtained. This color impression is permanent after a switching time of 25 seconds and no longer reverts back to the starting state even after reversal of polarity.

The electrochromically active formulations may be used for flashing electrochromic displays, especially for those which, in addition to the flashing, can also display a permanent symbol on the flashing display. The formulations include at least two chemically different color systems. The formulations are characterized in that the first color system is reversibly switchable at a low voltage, and so is suitable for flashing display of symbols. The second color system is activatable at a higher voltage and, due to its bistability or irreversibility, is suitable for the permanent display of symbols.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-9. (canceled)

10. An electrochromic formulation for an organic electronic component, comprising:
at least two chemically different color systems, including a first color system reversibly switchable at a low voltage and a second color system activatable at a higher voltage.

11. The formulation as claimed in claim 10, wherein the first color system is reversibly switchable at a voltage of about 1.5 V.

12. The formulation as claimed in claim 11, wherein the second color system is bistably and/or irreversibly switchable at a voltage of about 2 to 3V.

13. The formulation as claimed in claim 12, wherein the first color system comprises a 4,4′-bipyridinium salt.

14. The formulation as claimed in claim 13, wherein the second switchable color system comprises a sulfur compound which dimerizes in a redox system.

15. A process for producing an electrochromic formulation, comprising:
mixing an electrochromic color system which is reversibly switchable at low voltage with a bistably or irreversibly switchable color system to obtain a mixture; and
adding solvents to the mixture to produce the electrochromic formulation as a paste applicable to electrode layers.

16. An electrochromic organic electronic component, comprising:
at least two electrodes; and
at least one active electrochromic organic layer, between the at least two electrodes, providing at least two electrochromic color systems switchable at different voltages and/or power pulse lengths.

17. The component as claimed in claim 16, wherein at least one of the at least two electrodes is structured.

18. The component as claimed in claim 17, wherein said at least one active electrochromic organic layer has individual regions addressed with different voltages.
